(19) United States
(12) Patent Application Publication
(10) Pub. No.: US 2026/0118855 A1
(43) Pub. Date: Apr. 30, 2026

(54) ARTIFICIAL INTELLIGENCE-BASED BIAS PREDICTION FOR RUN-TO-RUN PROCESS CONTROL

(71) Applicant: Applied Materials, Inc., Santa Clara, CA (US)

(72) Inventor: Yi-Chieh Chen, Tainan (TW)

(21) Appl. No.: 19/038,351

(22) Filed: Jan. 27, 2025

Related U.S. Application Data
(60) Provisional application No. 63/712,129, filed on Oct. 25, 2024.

(51) Int. Cl. G05B 19/418

(52) U.S. Cl. CPC G05B 19/41845; G05B 2219/45031

(57) ABSTRACT

Methods and systems for artificial intelligence (AI)-based bias prediction for run-to-run (R2R) process control are provided. A process recipe and a target outcome of a substrate process to be performed using one or more manufacturing equipment are identified. The process recipe and the target outcome are provided as an input to a machine learning model trained to predict biases of current substrate processes performed using manufacturing equipment in view of prior substrate processes performed using the manufacturing equipment. One or more outputs of the machine learning model are obtained, where the one or more outputs include a bias of the substrate process in view of one or more prior substrate processes performed using the manufacturing equipment. One or more settings of the process recipe are updated based on the bias.

### CLAIM OF PRIORITY

The present application claims the benefit under 35 U.S.C. § 119 (e) of U.S. Provisional Patent Application No. 63/712,129 filed Oct. 25, 2024, which is incorporated by reference herein.

### TECHNICAL FIELD

Embodiments of the present disclosure relate, in general, to manufacturing systems and more particularly to artificial intelligence (AI)-based bias prediction for run-to-run (R2R) process control.

### BACKGROUND

As the size of electronic devices continue to shrink, substrate processing complexity has continued to increase. Some techniques for manufacturing substrates can involve multiple different processes, with some advanced techniques (e.g., plasma etching) involving twenty or even more different processes. A multitude of process control variables of a substrate process can impact characteristics of a respective substrate after the substrate process is completed. Run-to-run (R2R) process control refers to a technique of modifying a process recipe between runs in order to minimize drift, shift, and/or variability of substrates. Process control systems can modify a process recipe by modifying or tuning settings associated with one or more process control variables associated with the process recipe (e.g., to optimize the process, to cause characteristics of the respective substrate to correspond to target characteristics, etc.).

### SUMMARY

Some of the embodiments described cover a system and method for AI-based bias prediction for R2R process control. The method includes identifying, for a substrate process to be performed using one or more manufacturing equipment, a process recipe associated with the substrate process and a target outcome of the substrate process. The method further includes providing the process recipe and the target outcome as an input to a machine learning model trained to predict biases of current substrate processes performed using manufacturing equipment in view of prior substrate processes performed using the manufacturing equipment. The method further includes obtaining one or more outputs of the machine learning model. The one or more outputs include a bias of the substrate process in view of one or more prior substrate processes performed using the manufacturing equipment. The method further includes updating one or more settings of the process recipe based on the bias.

In some implementations, at least one of: the substrate process includes an etching process and the target outcome of the substrate process includes a target etching rate of the etching process, the substrate process includes a polishing process and the target outcome of the substrate process includes a target polishing rate of the polishing process, or the substrate process includes a deposition process and the target outcome of the substrate process includes a target deposition rate of the deposition process.

In some implementations, the process recipe includes at least one of a value of one or more settings associated with the substrate process or a duration of the substrate process.

In some implementations, the method further includes determining a statistical bias value for the substrate process based on contextual data associated with the prior substrate processes performed using the manufacturing equipment. The method further includes providing the determined statistical bias value as an additional input to the machine learning model.

In some implementations, the method further includes identifying metrology data for a substrate subject to the substrate process. The metrology data is obtained prior to performance of the substrate process. The method further includes providing the identified metrology data as an additional input to the machine learning model.

In some implementations, the method further includes providing, as an additional input to the machine learning model, an indication of a condition of a component of the one or more manufacturing equipment prior to the substrate process.

In some implementations, the method further includes identifying, for an additional substrate process to be performed using the one or more manufacturing equipment, an additional process recipe associated with the additional substrate process and an additional target outcome of the substrate process. The method further includes providing the additional process recipe and the additional target outcome of the substrate process. The method further includes obtaining one or more additional outputs of the machine learning model. The one or more additional outputs include an additional bias of the additional substrate process in view of the one or more prior substrate processes and the substrate process. The additional bias is different from the bias.

In some implementations, the additional substrate process is different from the substrate process.

In some implementations, updating the one or more settings of the process recipe based on the bias includes providing the bias as an input to one or more setting tuning operations associated with the one or more manufacturing equipment. The method further includes obtaining an output of the one or more setting tuning operations. The output includes an indication an updated value for the one or more settings in view of the bias.

In some implementations, a system includes a memory and a set of one or more processing devices coupled to the memory. The set of one or more processing devices is to generate training data for training a machine learning model to predict biases of current substrate processes performed using manufacturing equipment in view of prior substrate processes performed using the manufacturing equipment. To generate the training data, the set of one or more processing devices is to generate a training input including a process recipe associated with a first historical substrate process performed using one or more manufacturing equipment and an outcome of the first historical substrate process. The set of one or more processing devices is further to generate a target output for the training input. The target output includes a historical bias associated with the first historical substrate process in view of the outcome of the first historical substrate process and one or more second historical substrate processes performed using the one or more manufacturing equipment prior to the first historical substrate process. The set of one or more processing devices is further to provide the training data to train the machine learning model on (i) a set of training inputs including the training input and (ii) a set of target outputs including the target output.

In some implementations, the set of one or more processing devices is further to calculate the historical bias associated with the first historical process based on the outcome of the first historical substrate process, one or more settings of the process recipe, and metrology data collected for at least one of a substrate of the first historical substrate process or a substrate of the one or mor second historical substrate processes.

In some implementations, the set of one or more processing devices is further to determine a statistical bias value for the first historical substrate process based on contextual data associated with the one or more second historical substrate processes performed using the one or more manufacturing equipment. The training input is further generated based on the determined statistical bias value.

In some implementations, the training input is further generated based on a historical condition of a component of the one or more manufacturing equipment prior to the first historical substrate process and subsequent to the one or more second historical substrate processes.

In some implementations, at least one of: the first historical substrate process includes a historical etching process and the outcome of the first historical substrate process includes a historical etching rate of the historical etching process, the first historical substrate process includes a historical polishing process and the outcome of the first historical substrate process includes a historical polishing rate of the historical polishing process, or the first historical substrate process includes a historical deposition process and the outcome of the first historical substrate process includes a historical deposition rate of the historical deposition process.

In some implementations, the processing recipe for the first historical substrate process includes at least one of a value of one or more settings associated with the first historical process or a duration of the first historical substrate process.

In some implementations, the first historical substrate process is different from the one or more second historical substrate processes.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 depicts an illustrative system architecture, according to aspects of the present disclosure.

FIG. 2 is a block diagram of an example run-to-run (R2R) control engine, according to aspects of the present disclosure.

FIG. 3 is a flow chart of an example method for training an AI model, according to aspects of the present disclosure.

FIG. 4 is a flow chart of an example method for artificial intelligence (AI)-based bias prediction for R2R process control, according to aspects of the present disclosure.

FIG. 5 depicts a block diagram of an illustrative computer system operating in accordance with one or more aspects of the present disclosure.

### DETAILED DESCRIPTION OF EMBODIMENTS

Implementations described herein provide systems and methods for artificial intelligence (AI)-based bias prediction for run-to-run process control. In an electronic device manufacturing environment, run-to-run (R2R) control is a process control strategy for managing and optimizing performance of processes between consecutive production runs. As electronic device manufacturing involves highly precise and complex operations, small variations between production runs can accumulate and ultimately impact device quality. R2R control addresses this challenge by using data collected from a previous production run to adjust process parameters for a subsequent production run. For example, in processes like photolithography, chemical vapor deposition, etching, and so forth, R2R control can fine-tune parameters such as temperature, pressure, and chemical concentrations to correct for drift or deviations in previous runs.

As indicated above, small variations between production runs can accumulate, which, when unaddressed, can impact device quality. Such variation is referred to as a bias, which represents a deviation of an actual outcome of a process from a target outcome of the process. A process bias represents an error or deviation in the process itself, while a tool bias represents an error introduced by equipment used in the process. In an illustrative example, for a deposition process, a variation in chemical concentration, temperature, environmental changes, and so forth across processes in a fabrication environment can introduce a process bias that causes characteristics of devices manufactured according to such deposition process to drift away from target characteristics. In another illustrative example, a process chamber of a manufacturing system may be subject to wear, calibration issues, or inherent mechanical differences from other process chambers (e.g., of the manufacturing system). Accordingly, such process chamber may etch a substrate or a device more deeply than the other chambers, even when the same process recipe is applied, which is represented by a tool bias for the process chamber.

In view of the above, manufacturing systems attempt to identify and correct both process and tool biases between production runs, so to maintain consistency of devices manufactured according to such production runs. Conventionally, systems attempt to identify and/or quantify biases of manufacturing equipment and/or a process based on historical data collected for prior production runs at the manufacturing system. For example, a substrate process (e.g., an etching process, a deposition process, a polishing process, etc.) can be performed for a series of substrates using common manufacturing equipment. Prior to and/or after the substrate process, the system can obtain metrology data associated with a respective substrate, which can indicate one or more properties of the substrate (and/or a film of the substrate) prior to and/or after the substrate process. Based on the metrology data collected for each of the series of substrates, the system can determine differences between outcomes of the substrate process for each of the series of substrates and approximate (e.g., using statistical techniques or methods) a value representing a process bias for the substrate process and a value representing a tool bias for the manufacturing equipment based on the determined differences. The system can modify settings of a process recipe for the substrate process based on the approximated process bias and tool bias values for subsequent processes performed using the manufacturing equipment. In accordance with the previous illustrative examples, the system can modify settings of a process recipe for the deposition process to counteract the variation of the chemical concentration, temperature, environmental changes, etc. based on the approximated process bias value and/or can modify settings of a process recipe for the etch process at the process chamber to counteract the tool bias of the process chamber based on the approximated tool bias value.

A system collects and analyzes a significant amount of data (e.g., process data, metrology data, etc.) in order to accurately approximate the process bias and tool bias values according to the above described conventional technique. Such collection and analysis can take a significant amount of time and consume a large amount of computing resources (e.g., memory space, processing cycles), which are made unavailable to other processes of the system, decreasing the overall efficiency and increasing the overall latency of the system. Further, the system may collect data for approximation of the process bias and tool bias values during an initial time period and once a threshold amount of data is collected and the values are approximated, may use such values to correct for the biases during a subsequent time period. However, the process bias and/or tool bias may be present during substrate processes performed during the initial time period. As the system is unable to correct for the process bias and/or the tool bias during the initial time period (e.g., as the bias values are not known), substrates or devices subject to substrate processes during the initial time period may include variations or defects that render the substrates or devices unusable, which decreases an overall throughput of the system. In addition, the approximated bias values may only be relevant for substrate processes that are performed using the process recipe for which the values are approximated. Accordingly, if any changes are made to the process recipe (e.g., by a developer or operator of the manufacturing system), updated process bias values and/or tool bias values are to be determined, which can exacerbate the above described problems.

Aspects of the present disclosure address the above noted and other deficiencies by providing systems and methods for artificial intelligence (AI)-based bias prediction for run-to-run process control. A system can train an AI model (e.g., a machine learning model) to predict biases of current substrate processes performed using manufacturing equipment in view of prior substrate process performed using the manufacturing equipment. In some embodiments, the system can generate training data for training the machine learning model, which can include a set of training inputs and a set of target outputs. The system can generate the training input by identifying a process recipe associated with a first historical substrate process performed using the manufacturing equipment and an outcome of the first historical substrate process. In some embodiments, the process recipe can indicate values of one or more settings of the first historical substrate process and/or a duration of one or more operations of the first historical substrate process. The outcome of the first historical substrate process may represent or correspond to a metrology measurement collected for a substrate subject to the first historical substrate process, where such metrology measurement is based on a type of the first historical substrate process. For example, the first historical substrate process can be a historical etching process and therefore the outcome can include a historical etching rate of the historical etching process. In another example, the first historical substrate process can be a historical polishing process and therefore the outcome can include a historical polishing rate of the historical polishing process. In yet another example, the first historical substrate process can include a historical deposition process and therefore the outcome can include a historical deposition rate of the historical deposition process.

The system may determine a historical bias associated with the first historical substrate process in view of the outcome of the first historical substrate process and one or more second historical substrate processes performed using the manufacturing equipment prior to the first historical substrate process. In some embodiments, the system may calculate a value of the tool bias and/or the process bias based on the outcome of the first historical substrate process, one or more settings of the process recipe associated with the first historical substrate process and/or an aggregated outcome of the one or more second historical substrate processes. In an illustrative example, the outcome of the first historical substrate process can include a measured etch rate of the process. The system can calculate the value of the tool bias and/or the process bias by determining a difference between the measured etch rate of the first historical substrate process and an aggregate measured etch rate of the one or more second historical substrate processes in view of a duration of one or more etch operations of the first historical substrate process and/or the one or more second historical substrate processes. The calculated value of the tool bias and/or the process bias can be included or designated as the target output for the training data, in some embodiments. Further details regarding calculating the value of the tool bias and/or the process bias are described herein.

The system can update the training dataset to include the generated training input and the generated target output and can provide the training dataset (e.g., to a training engine) for training the machine learning model. Upon training of the machine learning model, the system can apply the trained machine learning model to data associated with substrate processes to be performed using the manufacturing equipment to determine a bias of the substrate processes. For example, the system can identify a process recipe associated with the substrate process and a target outcome (e.g., a target etch rate, a target deposition rate, a target polishing rate, etc.) of the substrate process. The system can provide the identified process recipe and the target outcome as an input to the trained machine learning model and can obtain one or more outputs of the model, which can indicate one or more predicted biases of the substrate process in view of one or more prior substrate processes performed using the manufacturing equipment. In some embodiments, the one or more predicted biases can include a predicted process bias and/or a predicted tool bias. In other or similar embodiments, the one or more predicted biases can include an overall bias that represents the total bias of the substrate process based on the process bias and the tool bias. The system can update one or more settings of the process recipe for the substrate process to counteract the process bias and tool bias, as described herein, and can perform one or more operations of the substrate process based on the updated settings.

Aspects of the present disclosure address deficiencies of the conventional technology by providing systems and methods for predicting a bias of a substrate process using artificial intelligence and/or machine learning techniques. Embodiments of the present disclosure enable the training of a machine learning model to predict biases that arise for multiple different types of substrate processes and/or across multiple different types of manufacturing equipment. The training data that is provided to train such machine learning model can be representative of the physical phenomena that occurs during a substrate process. Further, based on such training, the machine learning model can identify nonlinear relationships between factors of a substrate process (e.g., the process recipe, the target outcome, etc.). In view of the above, embodiments of the present disclosure enable the system to determine biases of a substrate process with improved accuracy and therefore quickly apply an appropriate correction to subsequent processes in view of the determined bias, which improves an overall efficiency, latency, and throughput of the system. Further, embodiments of the present disclosure enable the system to determine a bias of a substrate process that has been performed a limited number of times and/or has not been performed using the manufacturing equipment in a long period of time. The system can use the determined bias to update the process recipe of the substrate process earlier into the production schedule, therefore decreasing the overall number of substrates or devices that include variations or defects.

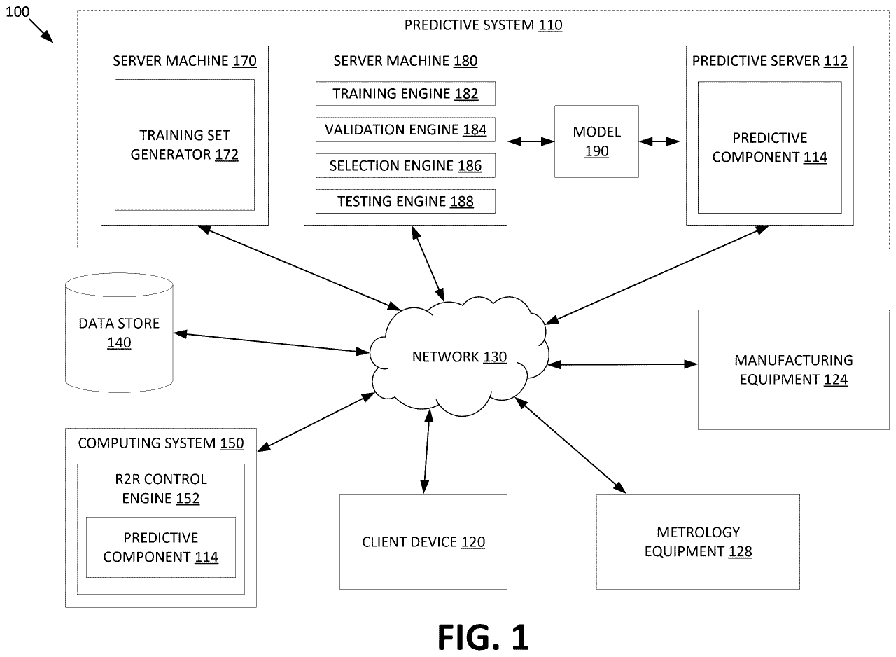

FIG. 1 depicts an illustrative system architecture 100, according to aspects of the present disclosure. System architecture 100 can include a client device 120, manufacturing equipment 124, metrology equipment 128, a predictive server 112 (e.g., to generate predictive data, to provide model adaptation, to use a knowledge base, etc.), and/or a data store 140. The predictive server 112 can be part of a predictive system 110. The predictive system 110 can further include server machines 170 and 180. In some embodiments, system architecture 100 can be included as part of a manufacturing system for processing substrates.

Manufacturing equipment 124 can produce products, such as electronic devices, following a recipe or performing runs over a period of time. Manufacturing equipment 124 can include a process chamber. Manufacturing equipment 124 can perform a process for a substrate (e.g., a wafer, etc.) at the process chamber. Examples of substrate processes include a deposition process to deposit a film on a surface of the substrate, an etch process to form a pattern on the surface of the substrate, a polishing process to polish a material on the surface of the substrate, etc. Manufacturing equipment 124 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc. Substrates that are processed according to a process recipe (e.g., for manufacturing a portion of an electronic device, etc.) are referred to herein as production substrates.

Manufacturing equipment 124 can include one or more sensors configured to capture data for a substrate being processed at the manufacturing system. In some embodiments, the manufacturing equipment 124 and the sensors can be part of a sensor system that includes a sensor server (e.g., field service server (FSS) at a manufacturing facility) and sensor identifier reader (e.g., front opening unified pod (FOUP) radio frequency identification (RFID) reader for sensor system). Sensor data may include a value of one or more of temperature (e.g., heater temperature), spacing (SP), pressure, high frequency radio frequency (HFRF), RF bias, voltage of electrostatic chuck (ESC), electrical current, flow, power, voltage, etc. Sensor data may be associated with or indicative of manufacturing parameters such as hardware parameters, such as settings or components (e.g., size, type, etc.) of the manufacturing equipment 124, or process parameters of the manufacturing equipment 124. The sensor data can be provided while the manufacturing equipment 124 is performing manufacturing processes (e.g., equipment readings when processing products). The sensor data 142 can be different for each substrate. In some embodiments, sensor data can include trace data collected during performance of one or more processes (e.g., substrate processes, maintenance processes, etc.) at manufacturing equipment 124. Trace data refers to data that indicates how components in a process chamber are operating and/or a state of an environment within a process chamber before, during, or after performance of an operation. Further details regarding sensor data are provided herein.

Metrology equipment 128 provides metrology data associated with substrates (e.g., production substrates, seasoning substrates, etc.) processed by manufacturing equipment 124. The metrology data can include a value of one or more of film property data (e.g., wafer spatial film properties), dimensions (e.g., thickness, height, etc.), dielectric constant, dopant concentration, density, defects, etc. In some embodiments, the metrology data can further include a value of one or more surface profile property data (e.g., an etch rate, an etch rate uniformity, a critical dimension of one or more features included on a surface of the substrate, a critical dimension uniformity across the surface of the substrate, an edge placement error, etc.). The metrology data can be of a finished or semi-finished product. The metrology data can be different for each substrate. Metrology equipment 128 can be configured to generate metrology data associated with a substrate before or after a substrate process and/or a maintenance process. In some embodiments, metrology equipment 128 can be part of a metrology system that includes a metrology server (e.g., a metrology database, metrology folders, etc.) and metrology identifier reader (e.g., FOUP RFID reader for metrology system).

Metrology equipment 128 can be integrated with a station of the process tool of manufacturing equipment 124. In some embodiments, metrology equipment 128 can be coupled to or be a part of a station of the process tool that is maintained under a vacuum environment (e.g., a process chamber, a transfer chamber, etc.). Such metrology equipment 128 is referred to as integrated metrology equipment. Accordingly, the substrate can be measured by the integrated metrology equipment while the substrate is in the vacuum environment. For example, after a process (e.g., an etch process, a deposition process, etc.) is performed for the substrate, the metrology data for the substrate can be generated by the integrated metrology equipment without the processed substrate being removed from the vacuum environment. In other or similar embodiments, metrology equipment 128 can be coupled to or be a part of the process tool station that is not maintained under a vacuum environment (e.g., a factory interface module, etc.). Such metrology equipment is referred to as inline metrology equipment. Accordingly, the substrate is measured by the inline metrology equipment outside of the vacuum environment.

In additional or alternative embodiments, metrology equipment 128 can include metrology measurement devices that are separate (i.e., external) from manufacturing equipment 124. For example, metrology equipment 128 can be standalone equipment that is not coupled to any station of manufacturing equipment 124. For a measurement to be obtained for a substrate using external metrology equipment, a user of a manufacturing system (e.g., an engineer, an operator) can cause a substrate processed at manufacturing equipment 124 to be removed from manufacturing equipment 124 and transferred to metrology equipment 128 for measurement. In some embodiments, metrology equipment 128 can transfer metrology data generated for the substrate to the client device 120 coupled to metrology equipment 128 via network 130 (e.g., for presentation to a manufacturing user, such as an operator or an engineer). In other or similar embodiments, the manufacturing system user can obtain metrology data for the substrate from metrology equipment 128 and can provide the metrology data to computer system architecture via a graphical user interface (GUI) of client device 120.

The client device 120 may include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. In some embodiments, the metrology data may be received from the client device 120. In some embodiments, client device 120 displays a graphical user interface (GUI), where the GUI enables the user to provide, as input, metrology measurement values for substrates processed at the manufacturing system. In other or similar embodiments, client device 120 can display another GUI that enables user to provide, as input, an indication of a type of substrate to be processed at the manufacturing system, a type of process to be performed for the substrate, and/or a type of equipment at the manufacturing system. In yet other or similar embodiments, client device 120 can display another GUI that that presents sensor data collected by sensors 126 before, during, or after performance of a process (e.g., a substrate process, a maintenance process, etc.). It should be noted that one or more GUIs of client device 120 can provide and/or receive any data described herein.

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers). The data store 140 can store data associated with processing a substrate at manufacturing equipment 124. For example, data store 140 can store data collected by sensors 126 at manufacturing equipment 124 before, during, or after a substrate process (referred to as process data). Process data can refer to historical process data (e.g., process data generated for a previous substrate processed at the manufacturing system) and/or current process data (e.g., process data generated for a current substrate processed at the manufacturing system). Current process data can be data for which predictive data is generated. In some embodiments, data store can store metrology data including historical metrology data (e.g., metrology measurement values for a prior substrate processed at the manufacturing system). The data store 140 can also store contextual data associated with one or more substrates processed at the manufacturing system. Contextual data can include a recipe name, recipe operation number, preventive maintenance indicator, operator, etc. In some embodiments, contextual data can also include an indication of a difference between two or more process recipes or process operations.

In some embodiments, data store 140 can be configured to store data that is not accessible to a user of the manufacturing system. For example, process data, spectral data, non-spectral data, and/or positional data obtained for a substrate being processed at the manufacturing system may not be accessible to a user of the manufacturing system. In some embodiments, all data stored at data store 140 is inaccessible by a user (e.g., an operator) of the manufacturing system. In other or similar embodiments, a portion of data stored at data store 140 is inaccessible by the user while another portion of data stored at data store 140 is accessible by the user. In some embodiments, one or more portions of data stored at data store 140 are encrypted using an encryption mechanism that is unknown to the user (e.g., data is encrypted using a private encryption key). In other or similar embodiments, data store 140 includes multiple data stores where data that is inaccessible to the user is stored in one or more first data stores and data that is accessible to the user is stored in one or more second data stores.

Computing system 150 can include a run-to-run (R2R) control engine 152 and/or predictive component 114. R2R control engine 152 can be configured to tune and/or modify process recipe settings for processes performed (or to be performed) using manufacturing equipment 124 in order to optimize the processes and/or cause characteristics of a substrate (e.g., following completion of the process) to correspond to target characteristics, etc. In some embodiments, R2R control engine 152 can tune and/or modify settings for a process recipe associated with a current process to be performed for a substrate at manufacturing equipment 124 in view of data associated with a prior process performed for the substrate and/or data associated with an upstream process performed for the substrate.

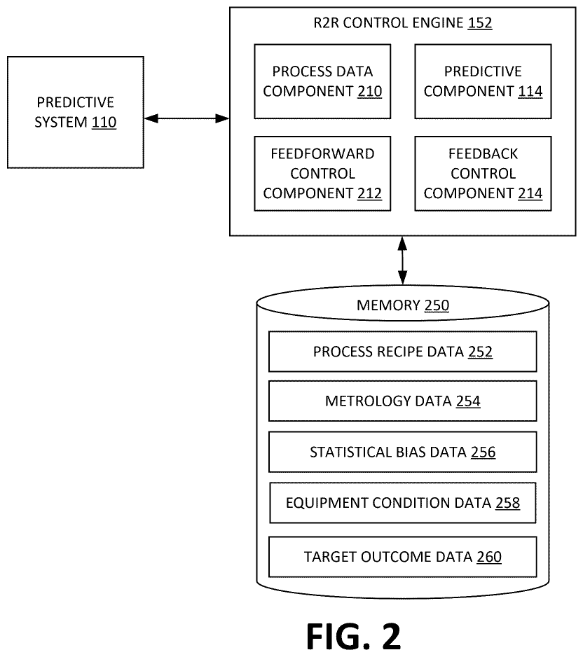

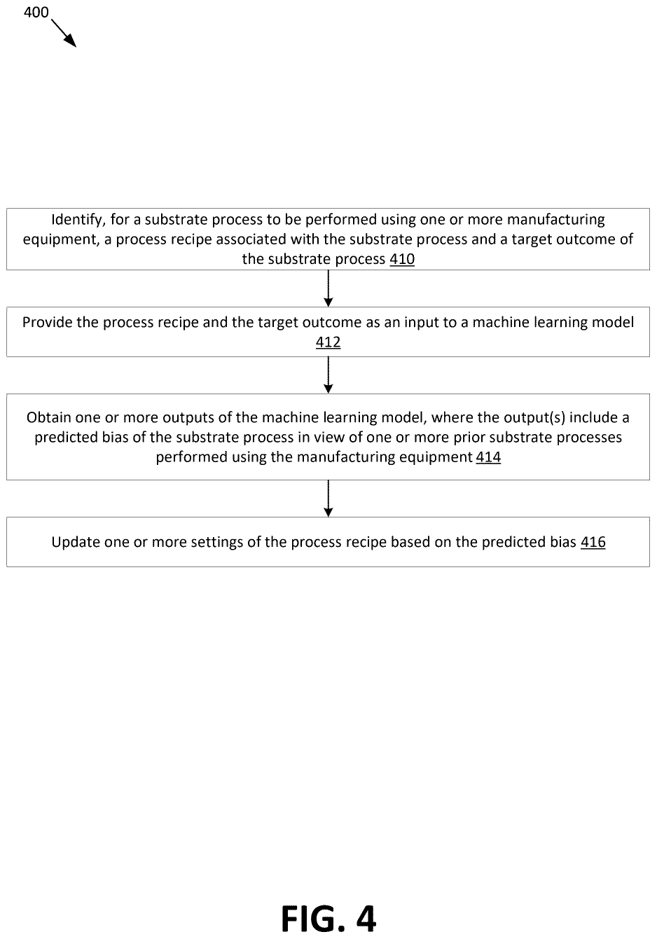

In some embodiments, R2R control engine 152 can determine a bias associated with a substrate process and can tune and/or modify the settings for the process recipe based on the determined bias. A bias refers to a variation or a deviation of an actual outcome of a process from a target outcome of the process. A bias can include a process bias (e.g., an error or deviation in the process itself) or a tool bias (e.g., an error introduced by equipment, such as equipment 124, used in the process). In some embodiments, R2R control engine 152 can determine the bias associated with a substrate process based on one or more outputs of an AI model (e.g., model 190). For example, predictive component 114 can provide a process recipe for the substrate process as an input to the model 190 and can obtain one or more outputs of the model 190. As described herein, model 190 can be trained to predict biases of current substrate processes performed using manufacturing equipment 124 in view of prior substrate processes performed using the manufacturing equipment. Details regarding training model 190 are described herein. The one or more outputs of model 190 can include a predicted bias (e.g., a predicted process bias, a predicted tool bias, etc.) of the substrate process in view of one or more prior substrate processes performed using manufacturing equipment 124. R2R control engine 152 can update one or more settings of a process recipe for the substrate process based on the predicted bias and can perform the substrate process based on the updated settings. Details regarding the predicted bias and updating the one or more settings are provided herein with respect to FIGS. 2 and 4.

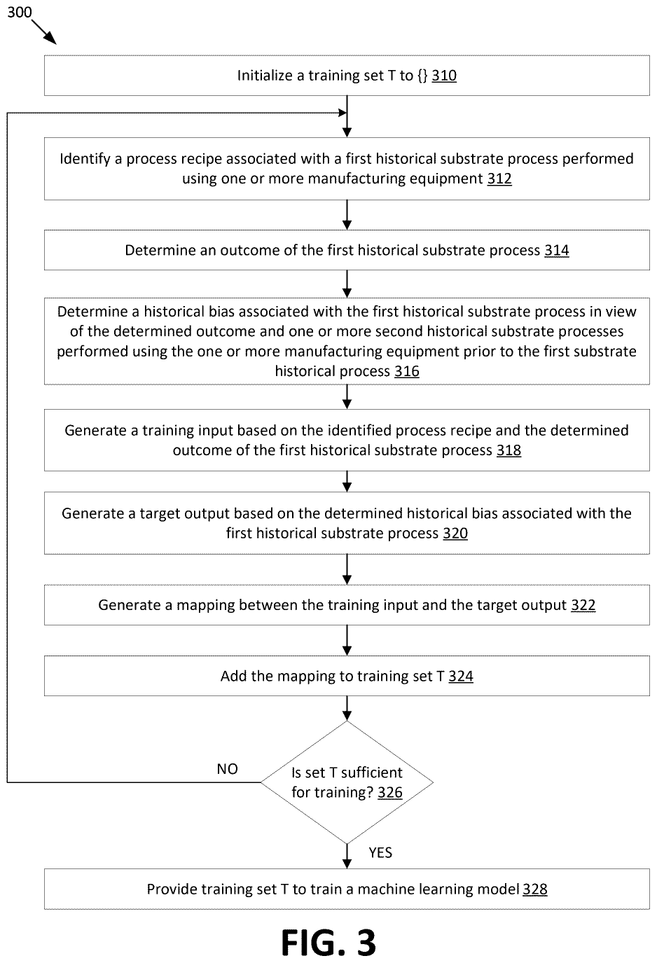

In some embodiments, predictive system 110 includes server machine 170 and server machine 180. Server machine 170 includes a training set generator 172 that is capable of generating training data sets (e.g., a set of data inputs and a set of target outputs) to train, validate, and/or test a machine learning model 190. Some operations of training set generator 172 are described in detail below with respect to FIG. 3. In some embodiments, the training set generator 172 can partition the training data into a training set, a validating set, and a testing set. In some embodiments, the predictive system 110 generates multiple sets of training data.

Server machine 180 includes a training engine 182, a validation engine 184, a selection engine 186, and/or a testing engine 188. An engine can refer to hardware (e.g., circuitry, dedicated logic, programmable logic, microcode, processing device, etc.), software (such as instructions run on a processing device, a general purpose computer system, or a dedicated machine), firmware, microcode, or a combination thereof. Training engine 182 can be capable of training a machine learning model 190. The machine learning model 190 can refer to the model artifact that is created by the training engine 182 using the training data that includes training inputs and corresponding target outputs (correct answers for respective training inputs). The training engine 182 can find patterns in the training data that map the training input to the target output (the answer to be predicted), and provide the machine learning model 190 that captures these patterns. In some embodiments, the machine learning model 190 uses one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network, a recurrent neural network, a convolutional neural network, etc.), clustering techniques (e.g., hierarchical clustering techniques), association techniques (e.g., apriori techniques), classification techniques (e.g., decision trees, random forest techniques, etc.), a variational recurrent auto-encoder, etc. It should be noted that although some embodiments of the present disclosure describe model 190 as a machine learning model, such embodiments can be applied to any type of AI model, non-AI based model (e.g., a statistical model, a physical model, etc.), and/or a hybrid model (e.g., implementing AI techniques and non-AI techniques).

The validation engine 184 can be capable of validating a trained machine learning model 190 using a corresponding set of features of a validation set from training set generator 172. The validation engine 184 can determine an accuracy of each of the trained machine learning models 190 based on the corresponding sets of features of the validation set. The validation engine 184 can discard a trained machine learning model 190 that has an accuracy that does not meet a threshold accuracy. In some embodiments, the selection engine 185 can be capable of selecting a trained machine learning model 190 that has an accuracy that meets a threshold accuracy. In some embodiments, the selection engine 185 can be capable of selecting the trained machine learning model 190 that has the highest accuracy of the trained machine learning models 190.

The testing engine 186 can be capable of testing a trained machine learning model 190 using a corresponding set of features of a testing set from data set generator 172. For example, a first trained machine learning model 190 that was trained using a first set of features of the training set can be tested using the first set of features of the testing set. The testing engine 186 can determine a trained machine learning model 190 that has the highest accuracy of all of the trained machine learning models based on the testing sets.

Predictive server 112 includes a predictive component 114 that is capable of data as an input to a trained model 190 and obtaining one or more outputs of the trained model 190. As described herein, predictive component 114 can be a component of or otherwise associated with R2R control engine 152 and can provide process recipe data and/or a target outcome for a substrate process as an input to trained model 190. Predictive component 114 can obtain one or more outputs of trained model 190, which can include a predicted bias of the substrate process in view of one or more prior processes performed using manufacturing equipment 124, as described herein.

The client device 120, manufacturing equipment 124, metrology equipment 128, predictive server 112, data store 140, server machine 170, and server machine 180 can be coupled to each other via a network 130. In some embodiments, network 130 is a public network that provides client device 120 with access to predictive server 112, data store 140, and other publicly available computing devices. In some embodiments, network 130 is a private network that provides client device 120 access to manufacturing equipment 124, metrology equipment 128, data store 140, and other privately available computing devices. Network 130 can include one or more wide area networks (WANs), local area networks (LANs), wired networks (e.g., Ethernet network), wireless networks (e.g., an 802.11 network or a Wi-Fi network), cellular networks (e.g., a Long-Term Evolution (LTE) network), routers, hubs, switches, server computers, cloud computing networks, and/or a combination thereof.

It should be noted that in some other implementations, the functions of server machines 170 and 180, as well as predictive server 112, can be provided by a fewer number of machines. For example, in some embodiments, server machines 170 and 180 can be integrated into a single machine, while in some other or similar embodiments, server machines 170 and 180, as well as predictive server 112, can be integrated into a single machine.

In general, functions described in one implementation as being performed by server machine 170, server machine 180, and/or predictive server 112 can also be performed on client device 120. In addition, the functionality attributed to a particular component can be performed by different or multiple components operating together.

In embodiments, a “user” can be represented as a single individual. However, other embodiments of the disclosure encompass a “user” being an entity controlled by a plurality of users and/or an automated source. For example, a set of individual users federated as a group of administrators can be considered a “user.”

FIG. 2 is a block diagram of an example run-to-run (R2R) control engine 152, according to aspects of the present disclosure. As described above, R2R control engine 152 can tune and/or modify settings of a process recipe for processes performed (or to be performed) using manufacturing equipment 124. In some embodiments, R2R control engine 152 can tune and/or modify the settings based on a bias determined for the substrate process. In some embodiments, R2R control engine 152 can be connected to predictive system 110 and/or memory 250 (e.g., via network 130). Memory 250 can include one or more portions of data store 140, in some embodiments. In other or similar embodiments, memory 250 can include any memory of or accessible to a component of system 100.

As described herein, R2R control engine 152 may determine a bias for a substrate process to be performed using manufacturing equipment 124 based on one or more outputs of a model 190. As illustrated by FIG. 2, R2R control engine 152 can include a process data component 210, a predictive component 114, a feedforward control component 212, and/or a feedback control component 214. Feedforward control component 212 can perform one or more operations associated with feedforward control (e.g., based on anticipated variations or deviations of an upcoming run for a substrate process). Feedback control component 214 can perform one or more operations associated with feedback control (e.g., based on detected variations or deviations of a previous run for the substrate process).

As described herein, model 190 can be trained to predict biases for current substrate processes performed using manufacturing equipment 124 in view of one or more prior substrate processes performed using manufacturing equipment 124. One or more components or engines of predictive system 110 may train model 190, as described below with respect to FIG. 3.

FIG. 3 is a flow chart of an example method for training an AI model, according to aspects of the present disclosure. Method 300 is performed by processing logic that can include hardware (circuitry, dedicated logic, etc.), software (such as is run on a general-purpose computer system or a dedicated machine), firmware, or some combination thereof. In one implementation, method 300 can be performed by a computer system, such as computer system architecture 100 of FIG. 1. In other or similar implementations, one or more operations of method 300 can be performed by one or more other machines not depicted in the figures. In some aspects, one or more operations of method 300 can be performed by predictive system 110. In other or similar aspects, one or more operations of method 300 can be performed by R2R control engine 152 of system 100.

For simplicity of explanation, method 300 is depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 310, processing logic initializes a training set T to an empty set (e.g., { }). At block 312, processing logic identifies a process recipe associated with a first historical substrate process performed using one or more manufacturing equipment. In some embodiments, processing logic (e.g., training set generator 172) can identify the process recipe based on process recipe data 252 for the first historical process. Process recipe data 252 can be provided by a user of system 100 (e.g., a user of client device 120) and/or a developer or operator of system 100 and/or client device 120, in some embodiments. In other or similar embodiments, process recipe data 252 can be determined based on experimental or test data associated with the first historical substrate process. The first historical process can include a historical etching process, a historical deposition process, a historical polishing process, or any other type of substrate process. In some embodiments, the first historical process was performed using manufacturing equipment 124. In other or similar embodiments, the first historical process was performed using other manufacturing equipment (e.g., of system 100 or of another system). The process recipe can include, in some embodiments, an indication of one or more settings of the first historical substrate process and/or a duration of one or more operations of the first historical substrate process.

At block 314, processing logic determines an outcome of the first historical process. The outcome can be reflected by metrology data 254 collected (e.g., using metrology equipment 128) for one or more substrates of the first historical substrate process before and/or after completion of the first historical substrate process. In some embodiments, metrology equipment 128 may generate metrology data 254, in accordance with embodiments described above. A type of the metrology data 254 collected for a substrate of the first historical substrate process can depend on a type of the substrate process. For example, for an etching process, the metrology data 254 can include an etch rate measured by metrology equipment 128. In another example, for a deposition process, the metrology data 254 can include a deposition rate, a film thickness, film characteristic data (e.g., indicating a composition of the film deposited on the substrate), and so forth. In yet another example, for a polishing process, the metrology data 254 can include a polishing rate, a material removal rate, and so forth. It should be noted that the outcome can be reflected by other data associated with the first historical substrate process. For example, the outcome can be reflected by one or more performance metrics (e.g., an efficiency, etc.) associated with the first historical substrate process.

In some embodiments, the outcome can be reflected by an aggregate of metrology data 254 collected for each substrate processed according to the first historical substrate process. For example, the first historical substrate process can be an etching process performed for multiple substrates using manufacturing equipment 124 (e.g., simultaneously, consecutively, etc.). Training set generator 172 can identify an etch rate measured for each of the multiple substrates (e.g., or a portion of the multiple substrates) and can determine an aggregate value of the identified etch rates. The aggregate value can include an average of the identified etch rates, a median of the identified etch rates, and so forth. In some embodiments the determined aggregate value of the identified etch rates can indicate the outcome of the first historical substrate process.

At block 316, processing logic determines a historical bias associated with the first historical substrate process in view of the determined outcome and one or more second historical substrate processes performed using the one or more manufacturing equipment prior to the first historical substrate process. In accordance with previously described embodiments, the historical bias can represent a historical process bias of the first historical substrate process and/or a historical tool bias of manufacturing equipment 124 during performance of the first historical substrate process. In some embodiments, the historical bias can be represented by the following formula:

Bias=Post Process Measurement−Total Process Outcome×Process Time,

where bias represents the historical bias, post process measurement represents the outcome of the first historical substrate process, total process outcome represents an aggregate value of the outcome of the first historical substrate process and the outcome of the one or more second historical substrate processes, and process time represents a duration of one or more operations of the process recipe for the first historical substrate process. In some embodiments, training set generator 172 an determine the total process outcome by determining the outcome of the one or more second historical substrate processes (e.g., based on metrology data 254) and calculating a value representing an aggregate (e.g., an average, a median, etc.) of the outcome of the first historical substrate process and the determined outcome of the one or more second historical substrate processes. In an illustrative example, training set generator 172 can determine the total process outcome based on an average of the etch rate measured for the first historical substrate process and the etch rates measured for each of the one or more second historical substrate processes. Training set generator 172 can determine the process time based on an indication of the duration of the one or more operations of the process (e.g., as included in process recipe data 252).

At block 318, processing logic can generate a training input based on the identified process recipe and the determined outcome of the first historical substrate process. The training input can indicate one or more settings of the identified process recipe and/or the determined outcome (e.g., the etch rate, the deposition rate, the polishing rate, etc.) of the first historical substrate process. In some embodiments, the training input can include additional data associated with the first historical substrate process and/or the manufacturing equipment 124. For example, training set generator 172 can determine a statistical bias value for the first historical substrate process based on contextual data associated with the one or more second historical substrate processes using manufacturing equipment 124. In some embodiments, training set generator 172, or another component of system 100, can calculate a state-space matrix, A0, for the first historical substrate process based on contextual data associated with the one or more second historical substrate processes. The state-space matrix, A0, can include one or more tool encoding values representing a state of a tool or equipment 124 used for a respective historical substrate process and one or more process encoding values representing a context or a state of the historical substrate process itself. The tool encoding values can be assigned or otherwise determined based on contextual data associated with manufacturing equipment 124, which can include a type of manufacturing equipment 124 and/or components of manufacturing equipment 124 used during the second historical substrate process, a condition of one or more components of the manufacturing equipment 124 during the second historical substrate process, and so forth. The process encoding values can be assigned or otherwise determined based on contextual data associated with the second historical substrate process, which can include a type of the second historical substrate process, a process recipe of the second historical substrate process, a one or more settings of the process recipe, a duration of the second historical substrate process, and so forth. In some embodiments, training set generator 172 can obtain a tool encoding or a process encoding for a second historical substrate process by providing contextual data, as described above, as an input to one or more encoding operations and obtaining one or more outputs of the encoding operations. Training set generator 172 can obtain the encoding according to other techniques, in some embodiments.

The formula below illustrates the state-space matrix, A0, that is calculated for the first historical substrate process:

$${A}_{0} = [ \begin{matrix}1 … 0 & 1 … 0 \\ 1 … 0 & 0 … 1 \\ 0 … 1 & 0 … 1\end{matrix} ]$$

where A0 represents the state-space matrix, a respective value in the left column of the matrix indicates a tool encoding for a respective second historical substrate process and a corresponding value in the right column of the matrix indicates a process encoding for the respective second historical substrate process. It should be noted that the encodings of the state-space matrix formula above are provided for purposes of example and illustration only and other values or other types of encoding values can be included in the state-space matrix A0.

Upon calculating the state-space matrix, A0, training set generator 172, and/or another component of system 100, can perform one or more statistical operations to approximate the bias of the first historical substrate process based on the tool biases and the process biases of each of the one or more second historical substrate processes. In some embodiments, the one or more statistical operations can include a linear matrix equation, which can be used to approximate the bias of the first historical substrate process. An example of the linear matrix equation is included below:

$${\hat{c}}_{k} = {( {A}^{T} Q A )}^{- 1} {A}_{0}^{T} Q \tilde{c}$$

where ĉₖ represents the bias of the first historical substrate process, A^{T} represents, Q represents a weight matrix used to assign preference to the current measurement versus past measurements and bias contribution estimation (e.g., for the second historical substrate processes), A₀^{T} represents the state-space matrix A0, explained above, and \tilde{c} represents a matrix including a r×1 vector of the total observed biases, e.g.,

$$[ \begin{matrix}{c}_{tot} \\ {\hat{c}}_{k}\end{matrix} ] .$$

In some embodiments, training set generator 172 can obtain the statistical bias value for the first historical substrate process based on the formulas explained above. Upon obtaining the statistical bias value, training set generator 172 can include the statistical bias value in the training input. In some embodiments, the statistical bias value can be included in statistical bias data 256 at memory 250. In other or similar embodiments, training set generator 172 can determine a condition of one or more components of manufacturing equipment 124 during performance of the first historical substrate process and/or the one or more second historical substrate process and include an indication of the determined equipment condition with the training input. In some embodiments, training set generator 172 can determine the condition of the one or more components based on equipment condition data 258 at memory 250. Equipment condition data 258 can be provided to system 100 (e.g., by a developer or operator of system 100) and/or can be determined based on sensor data and/or other data collected for manufacturing equipment 124. In an illustrative example, equipment condition data 258 for equipment 124 for a polishing process can include a condition of a polishing pad of the equipment 124, a lifetime of the polishing pad, and so forth.

At block 320, processing logic generates a target output based on the determined historical bias associated with the first historical process. The training input can include the historical bias calculated at block 316, in some embodiments. At block 322, processing logic generates a mapping between the training input and the target outputs. At block 324, processing logic adds the mapping to the training set T. At block 326, processing logic determines whether the training set T includes a sufficient amount of training data to train a machine learning model. It should be noted that in some implementations, the sufficiency of training set T can be determined based simply on the number of mappings in the training set, while in some other implementations, the sufficiency of training set T can be determined based on one or more other criteria (e.g., a measure of diversity of the training examples, etc.) in addition to, or instead of, the number of input/output mappings. Responsive to determining the training set does not include a sufficient amount of training data to train the machine learning model, method 300 returns to block 312. Responsive to determining the training set, T, includes a sufficient amount of training data to train the machine learning model, method 300 continues to block 328.

At block 328, processing logic provides training set T to train the machine learning model. In one implementation, the training set T is provided to training engine 182 of server machine 180 to perform the training. In the case of a neural network, for example, input values of a given input/output mapping are input to the neural network, and output values of the input/output mapping are stored in the output nodes of the neural network. The connection weights in the neural network are then adjusted in accordance with a learning algorithm (e.g., backpropagation, etc.), and the procedure is repeated for the other input/output mappings in the training set T. After block 328, machine learning model 190 can be used to predict a bias of a current substrate process performed using manufacturing equipment 124, as described herein.

Referring back to FIG. 2, R2R control engine 152 can determine a bias for a current substrate process based on one or more outputs of model 190 and use the determined bias for R2R control of the current substrate process. Embodiments relating to determining the bias for the current substrate process and using the determined bias for R2R control are described with respect to FIGS. 2 and 4.

FIG. 4 is a flow chart of an example method 400 for artificial intelligence (AI)-based bias prediction for R2R process control, according to aspects of the present disclosure. Method 400 is performed by processing logic that can include hardware (circuitry, dedicated logic, etc.), software (such as is run on a general-purpose computer system or a dedicated machine), firmware, or some combination thereof. In one implementation, method 400 can be performed by a computer system, such as computer system architecture 100 of FIG. 1. In other or similar implementations, one or more operations of method 400 can be performed by one or more other machines not depicted in the figures. In some aspects, one or more operations of method 400 can be performed by R2R control engine 152.

For simplicity of explanation, method 400 is depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 410, processing logic identifies, for a substrate process to be performed using one or more manufacturing equipment, a process recipe associated with the substrate process and a target outcome of the substrate process. In some embodiments, the substrate process can include an etching process, a deposition process, a polishing process, etc. that is to be performed using manufacturing equipment 124, as described above. Processing logic (e.g., process data component 210) can identify the process recipe based on process recipe data 252 at memory 250. The process recipe can include an indication of one or more operations of the substrate process and/or an indication of one or more settings of the operation(s). The one or more settings can include, but are not limited to, a temperature setting, a pressure setting, a gas flow setting for one or process and/or carrier gases of the substrate process, and so forth. The process recipe can additionally or alternatively include a duration of the one or more operations, in some embodiments.

In some embodiments, process data component 210 can identify the target outcome of the substrate process based on target outcome data 260 at memory 250. The target outcome data 260 can indicate the target outcome of the substrate process (e.g., a target etch rate, a target deposition rate or deposited film thickness, a target polishing rate, etc.). The target outcome data 260 can be provided by a developer or operator of system 100 and/or based on testing and/or experimental data collected for one or more prior processes performed using manufacturing equipment 124 (or other manufacturing equipment), in some embodiments.

At block 412, processing logic provides the process recipe and the target outcome as an input to a machine learning model. In some embodiments, predictive component 114 of R2R control engine can provide the process recipe and the target outcome as the input to model 190, in accordance with previously described embodiments. Predictive component 114 can additionally or alternatively provide other data as an input to model 190. For example, process data component 210 and/or predictive component 114 can obtain a statistical bias value for the substrate process based on contextual data associated with prior substrate processes performed using manufacturing equipment 124. The statistical bias value can be calculated or otherwise determined in accordance with embodiments described with respect to FIG. 3. In some embodiments, process data component 210 and/or predictive component 114 can obtain the statistical bias value from statistical bias data 256 at memory 250. In other or similar embodiments, process data component 210 and/or predictive component 114 can obtain data indicating a condition of one or more components of manufacturing equipment 124 from equipment condition data 258, in accordance with previously described embodiments. In yet other or similar embodiments, metrology equipment 128 can collect or otherwise generate metrology data 254 for a substrate subject to the substrate process (e.g., prior to performance of the substrate process), in accordance with previously described embodiments. Process data component 210 and/or predictive component 114 can obtain the generated metrology data 254 from memory 250. In some embodiments, predictive component 114 can provide the statistical bias value, the indication of the condition of the component(s) of manufacturing equipment 124, and/or the metrology data 254 as an additional input to model 190.

At block 414, processing logic obtains one or more outputs of the machine learning model. The one or more outputs include a predicted bias of the substrate process in view of one or more prior substrate processes performed using the manufacturing equipment. Predictive component 114 can obtain one or more outputs of model 190, which can include the predicted bias of the substrate process, as described herein. In some embodiments, the predicted bias can be a predicted tool bias or a predicted process bias, as described herein. In other or similar embodiments, the predicted bias can be an overall bias value representing both the tool bias and the process bias for the substrate process.

At block 416, processing logic updates one or more settings of the process recipe based on the predicted bias. In some embodiments, feedforward control component 212 can identify one or more settings of the process recipe for the substrate process to be updated based on the bias. In some embodiments, feedforward control component 212 can identify the one or more settings based on a type associated with the predicted bias. For example, the predicted bias can be a tool bias, and therefore feedforward control component 212 can identify one or more settings of the process recipe that are specific to or otherwise affected by a state of manufacturing equipment 124. In another example, the predicted bias can be a process bias, and therefore feedforward control component 212 can identify one or more settings of the process recipe that are specific to or otherwise affected by the process itself (e.g., regardless of the state of manufacturing equipment 124). In some embodiments, feedforward control component 212 can identify the one or more settings based on one or more pre-defined rules associated with updating settings of process recipes at system 100 (e.g., provided by a developer or operator of system 100). In other or similar embodiments, feedforward control component 212 can identify the one or more settings based on historical or experimental data for the system 100. Upon identifying the settings for updating, feedforward control component 212 can update the settings in accordance with a value of the predicted bias. For example, if the predicted bias indicates a degree of drift of a temperature in a process chamber, feedforward control component 212 can update a temperature setting of the process recipe based on the determined degree of drift indicated by the predicted bias.

In additional or alternative embodiments, feedforward control component 212 can update the setting(s) of the process recipe by providing the predicted bias as an input to one or more setting tuning operations associated with manufacturing equipment 124. The tuning operation(s) determine how much to address a setting to bring an actual outcome of a substrate process to a target outcome of the substrate process (e.g., therefore eliminating the predicted bias of the process). In some embodiments, the tuning operation(s) can output a tuning value for one or more settings of a process recipe based on a given bias. Feedforward control component 212 can obtain one or more outputs of the setting tuning operation(s) and update the settings of the process recipe based on the one or more outputs.

Upon updating the settings of the process recipe, R2R control engine 152 can perform one or more operations to initiate the substrate process at manufacturing equipment 124 based on the updated settings of the process recipe. For example, R2R control engine 152 can transmit a signal to a system controller associated with manufacturing equipment 124, where the signal includes an instruction to cause the system controller to initiate the substrate process using equipment 124 according to the updated settings.

As described herein, feedforward control component 212 can update one or more settings of a substrate process prior to performance of the substrate process and can cause the substrate process to be performed according to the updated settings. In additional or alternative embodiments, feedback control component 1214 can update one or more settings of a substrate process during or after a performance of the substrate process (e.g., for a first set of substrates) and can cause the substrate process to be performed for a second set of substrates according to the updated settings. For example, R2R control component 214 can obtain the predicted bias of a substrate process for a first set of substrates, in accordance with embodiments described herein. Feedback control component 214 can update a process recipe associated with a second set of substrates (e.g., that are to be processed subsequent to the first set of substrates) based on the predicted bias of the substrate process for the first set of substrates and/or additional data indicating an actual bias detected for the substrate process for the first set of substrates (e.g., in view of metrology data 254).

R2R control engine 152 can determine the predicted bias for each subsequent substrate process performed using manufacturing equipment 124, as described above. For example, responsive to performing the substrate process according to the updated process recipe settings, R2R control engine 152 can identify an additional process recipe associated with an additional substrate process and an additional target outcome of the substrate process, as described above. R2R control engine 152 can provide the additional process recipe and the additional target outcome as an input to model 190 and obtain one or more outputs, which include an additional substrate process in view of the prior substrate processes (e.g., for which the bias for the substrate process was predicted) and the substrate process. In some embodiments, the additional bias can be different from the bias predicted for the substrate process (e.g., in view of a change of a condition of manufacturing equipment 124 during or following the performance of the substrate process).

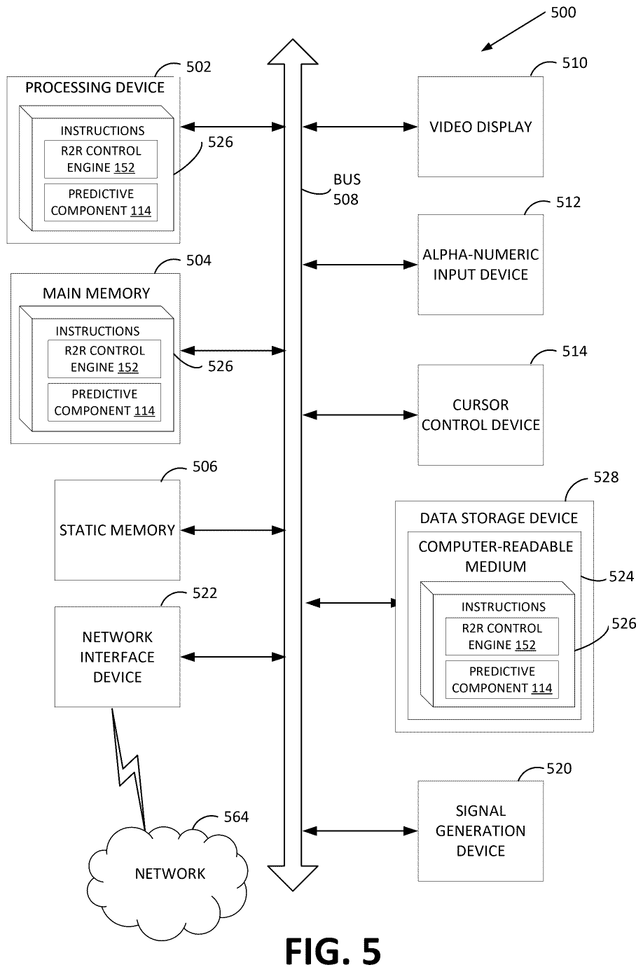

FIG. 5 depicts a block diagram of an illustrative computer system 500 operating in accordance with one or more aspects of the present disclosure. In alternative embodiments, the machine can be connected (e.g., networked) to other machines in a Local Area Network (LAN), an intranet, an extranet, or the Internet. The machine can operate in the capacity of a server or a client machine in a client-server network environment, or as a peer machine in a peer-to-peer (or distributed) network environment. The machine can be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein. In embodiments, computing device 500 can correspond to predictive server 112 of FIG. 1 or another processing device of system 100. In other or similar embodiments, computing device 500 can correspond to computing system 150 of system 100.

The example computing device 500 includes a processing device 502, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 528), which communicate with each other via a bus 508.

Processing device 502 can represent one or more general-purpose processors such as a microprocessor, central processing unit, or the like. More particularly, the processing device 502 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. Processing device 502 can also be or include a system on a chip (SoC), programmable logic controller (PLC), or other type of processing device. Processing device 502 is configured to execute the processing logic for performing operations and steps discussed herein.

The computing device 500 can further include a network interface device 522 for communicating with a network 564. The computing device 500 also can include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 528 can include a machine-readable storage medium (or more specifically a non-transitory computer-readable storage medium) 524 on which is stored one or more sets of instructions 526 embodying any one or more of the methodologies or functions described herein. Wherein a non-transitory storage medium refers to a storage medium other than a carrier wave. The instructions 526 can also reside, completely or at least partially, within the main memory 504 and/or within the processing device 502 during execution thereof by the computer device 500, the main memory 504 and the processing device 502 also constituting computer-readable storage media.

The computer-readable storage medium 524 can also be used to store model 190 and data used to train model 190. The computer readable storage medium 524 can also store a software library containing methods that call model 190. While the computer-readable storage medium 524 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of operations of each method can be altered so that certain operations can be performed in an inverse order so that certain operations can be performed, at least in part, concurrently with other operations. In another embodiment, instructions or sub-operations of distinct operations can be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
identifying, for a substrate process to be performed using one or more manufacturing equipment, a process recipe associated with the substrate process and a target outcome of the substrate process;
providing the process recipe and the target outcome as an input to a machine learning model trained to predict biases of current substrate processes performed using manufacturing equipment in view of prior substrate processes performed using the manufacturing equipment;
obtaining one or more outputs of the machine learning model, wherein the one or more outputs comprise a bias of the substrate process in view of one or more prior substrate processes performed using the manufacturing equipment; and
updating one or more settings of the process recipe based on the bias.

2. The method of claim 1, wherein at least one of:
the substrate process comprises an etching process and the target outcome of the substrate process comprises a target etching rate of the etching process,
the substrate process comprises a polishing process and the target outcome of the substrate process comprises a target polishing rate of the polishing process, or
the substrate process comprises a deposition process and the target outcome of the substrate process comprises a target deposition rate of the deposition process.

3. The method of claim 1, wherein the process recipe comprises at least one of a value of one or more settings associated with the substrate process or a duration of the substrate process.

4. The method of claim 1, further comprising:
determining a statistical bias value for the substrate process based on contextual data associated with the prior substrate processes performed using the manufacturing equipment; and
providing the determined statistical bias value as an additional input to the machine learning model.

5. The method of claim 1, further comprising:
identifying metrology data for a substrate subject to the substrate process, wherein the metrology data is obtained prior to performance of the substrate process; and
providing the identified metrology data as an additional input to the machine learning model.

6. The method of claim 1, further comprising:
providing, as an additional input to the machine learning model, an indication of a condition of a component of the one or more manufacturing equipment prior to the substrate process.

7. The method of claim 1, further comprising:
identifying, for an additional substrate process to be performed using the one or more manufacturing equipment, an additional process recipe associated with the additional substrate process and an additional target outcome of the substrate process;
providing the additional process recipe and the additional target outcome of the substrate process; and
obtaining one or more additional outputs of the machine learning model, wherein the one or more additional outputs comprise an additional bias of the additional substrate process in view of the one or more prior substrate processes and the substrate process,
wherein the additional bias is different from the bias.

8. The method of claim 7, wherein the additional substrate process is different from the substrate process.

9. The method of claim 1, wherein updating the one or more settings of the process recipe based on the bias comprises:
providing the bias as an input to one or more setting tuning operations associated with the one or more manufacturing equipment; and
obtaining an output of the one or more setting tuning operations, wherein the output comprises an indication an updated value for the one or more settings in view of the bias.

10. A system comprising:
a memory; and
a set of one or more processing devices coupled to the memory, wherein the set of one or more processing devices is to:
generate training data for training a machine learning model to predict biases of current substrate processes performed using manufacturing equipment in view of prior substrate processes performed using the manufacturing equipment, wherein to generate the training data, the set of one or more processing devices is to:
generate a training input comprising a process recipe associated with a first historical substrate process performed using one or more manufacturing equipment and an outcome of the first historical substrate process;
generate a target output for the training input, wherein the target output comprises a historical bias associated with the first historical substrate process in view of the outcome of the first historical substrate process and one or more second historical substrate processes performed using the one or more manufacturing equipment prior to the first historical substrate process; and
provide the training data to train the machine learning model on (i) a set of training inputs comprising the training input and (ii) a set of target outputs comprising the target output.

11. The system of claim 10, wherein the set of one or more processing devices is further to:
calculate the historical bias associated with the first historical process based on:
the outcome of the first historical substrate process,
one or more settings of the process recipe, and
metrology data collected for at least one of a substrate of the first historical substrate process or a substrate of the one or mor second historical substrate processes.

12. The system of claim 10, wherein the set of one or more processing devices is further to:
determine a statistical bias value for the first historical substrate process based on contextual data associated with the one or more second historical substrate processes performed using the one or more manufacturing equipment,
wherein the training input is further generated based on the determined statistical bias value.

13. The system of claim 10, wherein the training input is further generated based on a historical condition of a component of the one or more manufacturing equipment prior to the first historical substrate process and subsequent to the one or more second historical substrate processes.

14. The system of claim 10, wherein at least one of:
the first historical substrate process comprises a historical etching process and the outcome of the first historical substrate process comprises a historical etching rate of the historical etching process,
the first historical substrate process comprises a historical polishing process and the outcome of the first historical substrate process comprises a historical polishing rate of the historical polishing process, or
the first historical substrate process comprises a historical deposition process and the outcome of the first historical substrate process comprises a historical deposition rate of the historical deposition process.

15. The system of claim 10, wherein the processing recipe for the first historical substrate process comprises at least one of a value of one or more settings associated with the first historical process or a duration of the first historical substrate process.

16. The system of claim 10, wherein the first historical substrate process is different from the one or more second historical substrate processes.

17. A non-transitory computer readable medium comprising instructions that, when executed by a processing device, cause the processing device to:
identifying, for a substrate process to be performed using one or more manufacturing equipment, a process recipe associated with the substrate process and a target outcome of the substrate process;
providing the process recipe and the target outcome as an input to a machine learning model trained to predict biases of current substrate processes performed using manufacturing equipment in view of prior substrate processes performed using the manufacturing equipment;
obtaining one or more outputs of the machine learning model, wherein the one or more outputs comprise a bias of the substrate process in view of one or more prior substrate processes performed using the manufacturing equipment; and
updating one or more settings of the process recipe based on the bias.

18. The non-transitory computer readable medium of claim 17, wherein at least one of:
the substrate process comprises an etching process and the target outcome of the substrate process comprises a target etching rate of the etching process,
the substrate process comprises a polishing process and the target outcome of the substrate process comprises a target polishing rate of the polishing process, or
the substrate process comprises a deposition process and the target outcome of the substrate process comprises a target deposition rate of the deposition process.

19. The non-transitory computer readable medium of claim 17, wherein the process recipe comprises at least one of a value of one or more settings associated with the substrate process or a duration of the substrate process.

20. The non-transitory computer readable medium of claim 17, wherein the operations further comprise:
determining a statistical bias value for the substrate process based on contextual data associated with the prior substrate processes performed using the manufacturing equipment; and
providing the determined statistical bias value as an additional input to the machine learning model.
